(19) United States
(12) Patent Application Publication
(10) Pub. No.: US 2025/0389745 A1
(43) Pub. Date: Dec. 25, 2025

(54) PIEZOELECTRIC DEICING FOR PROBE FACEPLATE

(71) Applicant: Rosemount Aerospace Inc., Burnsville, MN (US)

(72) Inventors: Sathish Thangavel, Bangalore (IN); Sugumaran Selvaraj, Bangalore (IN); Greg Seidel, Lakeville, MN (US)

(21) Appl. No.: 19/184,640

(22) Filed: Apr. 21, 2025

(30) Foreign Application Priority Data
Jun. 21, 2024 (IN) 202411047886

(51) Int. Cl. G01P 1/00; G01P 5/00

(52) U.S. Cl. CPC G01P 1/00; G01P 5/00

(57) ABSTRACT

A deicing system may include a piezoelectric actuator coupled to an air data probe and configured to vibrate a surface of the air data probe, wherein a vibration of the surface of the air data probe causes a removal of ice from the surface of the air data probe. A deicing system may include a piezoelectric controller configured to control the vibration of the surface of the air data probe by the piezoelectric actuator.

### CROSS-REFERENCE TO RELATED APPLICATION

This nonprovisional application claims the benefit of priority of Indian Patent Application 202411047886 filed Jun. 21, 2024, which is hereby incorporated by reference in its entirety.

### BACKGROUND

Modern aircraft use externally mounted air data probes to measure air data parameters during flight. Air data parameters may include barometric static pressure, altitude, air speed, angle of attack, angle of sideslip, temperature, total air temperature, relative humidity, and other parameters of interest. Examples of air data probes include pitot probes, aspirated total air temperature probes, flush total air temperature probes, statics ports, or angle of attack sensors.

Because air data probes are mounted to the exterior of an aircraft to gain exposure to external airflow, the air data probes are exposed to the environmental conditions exterior of the aircraft, which are often cold. Because of this, air data probes must be heated to ensure the air data probes function properly in liquid water, ice crystal, and mixed phase icing conditions, as ice growth on the faceplate and body of the air data probes can cause measurement errors. However, due to the small size and position of these probes on the aircraft, it is difficult to place heating elements on or near the air data probe, such as on a base plate, that can effectively prevent icing of the air data probe. Furthermore, heating elements used for external probes often consume considerable amounts of power and have relatively short life spans. Therefore, there is a need for system and method for deicing air data probes and/or air data probe base plates.

### SUMMARY

In some aspects, the techniques described herein relate to a deicing system including: a piezoelectric actuator coupled to an air data probe and configured to vibrate a surface of the air data probe, wherein a vibration of the surface of the air data probe causes a removal of ice from the surface of the air data probe; and a piezoelectric controller configured to control the vibration of the surface of the air data probe by the piezoelectric actuator.

In some aspects, the techniques described herein relate to a deicing system, wherein the piezoelectric actuator is positioned within or upon a faceplate of the air data probe.

In some aspects, the techniques described herein relate to a deicing system, wherein the piezoelectric actuator is positioned upon an inner side of a faceplate of the air data probe.

In some aspects, the techniques described herein relate to a deicing system, wherein the piezoelectric actuator is positioned inside a groove within a faceplate of the air data probe.

In some aspects, the techniques described herein relate to a deicing system, wherein the piezoelectric actuator is activated upon a detection of ice on the air data probe.

In some aspects, the techniques described herein relate to a deicing system, wherein the detection of ice is caused by a monitoring voltage generated by the piezoelectric actuator.

In some aspects, the techniques described herein relate to a deicing system, wherein the piezoelectric actuator is configured to vibrate at a frequency equal to or greater than 20 kHz.

In some aspects, the techniques described herein relate to a deicing system, further including a heat element controlled by a heat element controller.

In some aspects, the techniques described herein relate to a deicing system, further including at least one of a faceplate or probe body of the air data probe.

In some aspects, the techniques described herein relate to a deicing system, wherein the air data probe includes at least one of a pitot probe, a total air temperature probe, or an angle of attack probe.

In some aspects, the techniques described herein relate to a deicing system, wherein the air data probe includes a pitot probe.

In some aspects, the techniques described herein relate to a deicing system, wherein the piezoelectric controller includes: an input protection unit configured to receive input power from a power source and output a power output; a boost power supply unit configured to receive the power output and provide a voltage-boosted power output; and a piezoelectric driver control unit electrically coupled configured to the piezoelectric actuator and configured to receive the voltage-boosted power output and provide an actuation power to the piezoelectric actuator.

In some aspects, the techniques described herein relate to a deicing system, wherein the air data probe includes a probe body and a faceplate, wherein the probe body extends outward from the faceplate, wherein the piezoelectric actuator includes one or more piezoelectric patches positioned on or within the faceplate.

In some aspects, the techniques described herein relate to a deicing system, wherein the faceplate includes one or more piezoelectric patches arranged in a contiguous path around the probe body.

In some aspects, the techniques described herein relate to a deicing system, wherein the faceplate includes one or more piezoelectric patches arranged in a discontinuous path around the probe body.

In some aspects, the techniques described herein relate to a deicing system, wherein the faceplate includes two sets of piezoelectric patches positioned on opposite sides of the probe body.

In some aspects, the techniques described herein relate to a system including: an air data probe including: a faceplate: a probe body extending outward from the faceplate; and a piezoelectric actuator coupled to the faceplate and configured to vibrate a surface of the air data probe, wherein a vibration of the surface of the air data probe causes a removal of ice from the surface of the air data probe; and a piezoelectric controller configured to control the vibration of the surface of the air data probe by the piezoelectric actuator.

In some aspects, the techniques described herein relate to a system, wherein the air data probe includes at least one of a pitot probe, an aspirated total air temperature probe, a flush total air temperature probe, a static port, or an angle of attack probe.

In some aspects, the techniques described herein relate to a system, wherein the piezoelectric controller includes: an input protection unit configured to receive input power from a power source and output a power output; a boost power supply unit configured to receive the power output and provide a voltage-boosted power output; and a piezoelectric driver control unit electrically coupled configured to the piezoelectric actuator and configured to receive the voltage-boosted power output and provide an actuation power to the piezoelectric actuator.

In some aspects, the techniques described herein relate to a method for deicing a component of an air data probe including: monitoring an icing status of air data probe via an icing detection system; and upon a detection of ice on the air data probe, providing actuation power to a piezoelectric actuator of a deicing system, wherein providing actuation power to the piezoelectric actuator of the deicing system causes a removal of ice from the air data probe.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a conceptual view of a deicing system for an air data probe, in accordance with one or more embodiments of the present disclosure.

FIG. 2 illustrates an enhanced conceptual view of a deicing system for an air data probe, in accordance with one or more embodiments of the present disclosure.

FIG. 3A illustrates plan views of three air data probes, in accordance with one or more embodiments of the disclosure

FIG. 3B illustrates a perspective view of an air data probe, in accordance with one or more embodiments of the disclosure.

FIG. 4 illustrates a process flow diagram depicting a method for deicing a component of an air data probe, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Reference will now be made in detail to the subject matter disclosed, which is illustrated in the accompanying drawings.

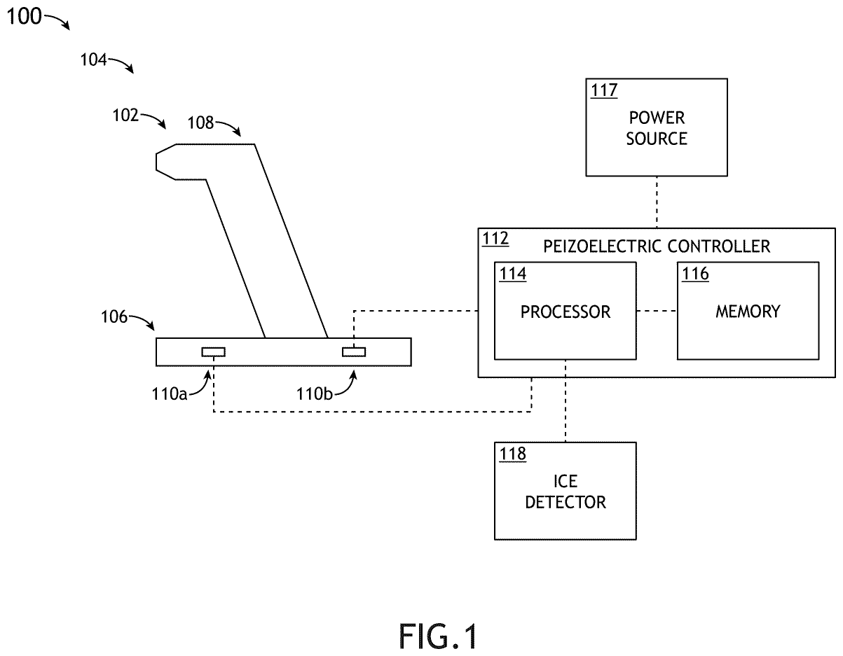

FIGS. 1 through 4 illustrate a system and method for deicing an air data probe in accordance with one or more embodiments of the present disclosure. Embodiments of the present disclosure are directed to a deicing system that includes a piezoelectric actuator coupled to a component of the air data probe, such as a faceplate. Upon a detection of ice on the air data probe, the piezoelectric actuator is activated, producing a vibration that causes ice to fall off of the air data probe. The piezoelectric actuator is controlled by a piezoelectric controller and is powered by an on-board power supply

Embodiments of the present disclosure are particularly advantageous as the deicing system can be implemented with minimal modifications to existing air data probes. For example, the deicing system can be implemented as an add-on deicing system to existing air data probes that have heat-based deicing components. Because the piezoelectric actuator does not include heating elements that use considerable heat and have limited life spans, the deicing system is longer-lasting and more energy-saving than heat-based deicing systems.

FIG. 1 illustrates a conceptual view of a deicing system 100 for an air data probe 102, in accordance with one or more embodiments of the present disclosure. The deicing system 100 may include or be incorporated within any type of vehicle including, but not limited to, an aircraft 104. For example, the deicing system 10 may include or be incorporated within a commercial airliner.

In embodiments, the deicing system 100 may include, or be incorporated within, the air data probe 102. The air data probe 102 may include any measuring device disposed on the surface of a vehicle (e.g., aircraft 104). For example, the air data probe 102 may include a pitot tube for measuring airspeed, angle of attack sensors for gauging the angle between the oncoming air and the wing chord line, total air temperature probes (e.g., an aspirated total air temperature probe or a flush total air temperature probe), a static port, radar altimeters to provide precise altitude readings, and/or other air data probes for measuring parameters such as sideslip and total air temperature. For example, the deicing system 100 may include, or be incorporated within, a pitot tube of a commercial airliner. The air data probe 102 may include one or more physical components. For example, the air data probe 102 may include a faceplate 106 and a probe body 108 that extends from the faceplate 106. For instance, the faceplate may be disposed upon, or be integrated into, the external skin of an aircraft 104, with the probe body 108 extending from the faceplate 106, and therefore the aircraft skin of the aircraft 104. In another example, the air data probe 102 may include a flush mounting, such as a flush mounting for the flush total air temperature probe and/or static port.

In embodiments, the deicing system 100 includes one or more piezoelectric actuators 110a-b. Piezoelectric actuators 110 are devices that use the piezoelectric effect to convert electrical energy into mechanical motion, such as a vibration that can cause ice to dissociate from an object such as the air data probe 102. The piezoelectric actuators 110 may be positioned on, integrated within, or otherwise positioned on one or more components of the air data probe 102. For example, the one or more piezoelectric actuators 110 may be positioned within or upon the faceplate 106 of the air data probe 102. In another example, the one or more piezoelectric actuators 110 may be positioned upon an inner side of the faceplate 106 of the air data probe 102. In another example, the one or more piezoelectric actuators 110 may be positioned inside a groove of the faceplate 106 of the air data probe 102. In another example, the one or more piezoelectric actuators 110 may be positioned on, or otherwise integrated into, the probe body 108.

In embodiments, the deicing system 100 includes a piezoelectric controller 112 communicatively coupled to the faceplate 106 and configured to control the vibration of a surface (e.g., a faceplate surface or a probe body surface) of the air data probe 102 by the piezoelectric actuator 110. The piezoelectric controller 112 includes one or more processors 114, wherein the one or more processors are configured to execute a set of program instructions stored in a memory 116. For example, the set of program instructions may be configured to cause the one or more processors 114 to monitor an icing status of the air data probe 102 or receive a status of the icing status of the air data probe (e.g., via an icing detection system). In another example, the set of program instructions may be configured to cause the one or more processors 114 to cause the one or more piezoelectric actuators 110 to receive an actuation power (e.g., electrical power that causes the piezoelectric actuators 110 to vibrate). In another example, the set of program instructions may be configured to cause the one or more processors 114 to cause the one or more piezoelectric actuators 110 to stop vibrating after a predetermined time or after an indication that ice is no longer formed on one or more components of the air data probe 102. The piezoelectric controller 112 receives power from a power source 117 (e.g., an aircraft battery and/or power generator).

In embodiments, the deicing system includes an ice detector 118 communicatively coupled to the piezoelectric controller 112. The ice detector 118 may include any type of ice detector or ice detection technology including, but not limited to, mechanical ice detectors, thermal ice detectors, and ultrasonic ice detectors that use sound wave propagation to detect ice formation. optical ice detectors that use light (e.g., lasers) to detect ice accumulation by measuring the reflection and refraction of light), and capacitance-based ice sensors that measure the dielectric constant of the air and the ice.

In embodiments, one or more piezoelectric actuators 110 are configured to detect ice formation. For example, when the deicing system is inactive (e.g., not receiving actuation power and ice has started forming on one or more components of the air data probe 102, one of the one or more piezoelectric actuators 110 may vibrate with a vibration signature indicating the presence of ice on the air data probe 102. This vibration signature results in a voltage (e.g., a monitoring voltage) that can be detected or received by the piezoelectric controller 112, which then activates the piezoelectric actuators 110, causing a vibration that causes the removal of ice from the air data probe 102. In some embodiments, the detection of ice through the one or more piezoelectric actuators 110 is a secondary ice detector for the air data probe 102. For example, an aircraft 104 may include a primary ice detector 118 based on one or more of the technologies disclosed herein and use the one or more piezoelectric actuators 110 as a secondary ice detector, so that if the primary ice detector 118 fails, the one or more piezoelectric actuators 110 could be used for ice detection.

In embodiments, the one or more piezoelectric actuators 110 are configured to vibrate at a deicing frequency (e.g., as determined by the piezoelectric controller 112). For example, the deicing frequency may include a frequency in a range of 100 Hz to 200 kHz, in a range of 5 kHz to 100 kHz, in a range of 10 kHz to 70 kHz, or in a range of 20 kHz to 50 kHz. In another example, the deicing frequency may be equal to or greater than 100 Hz, may be equal of greater than 5 kHz, may be equal to or greater than 10 kHz, may be equal to or greater than 20 kHz, may be equal to or greater than 50 kHz, or may be equal to or greater than 100 kHz. For instance, the deicing frequency may be approximately 20 kHz. For instance, the deicing frequency may be in a range of 100 Hz to 5000 Hz). Once vibrating at the deicing frequency, the piezoelectric actuators 110 will cause one or more adjacent surfaces of the air data probe 102 to vibrate, causing ice to crack, break up, or otherwise detach from the one or more adjacent surfaces of the air data probe.

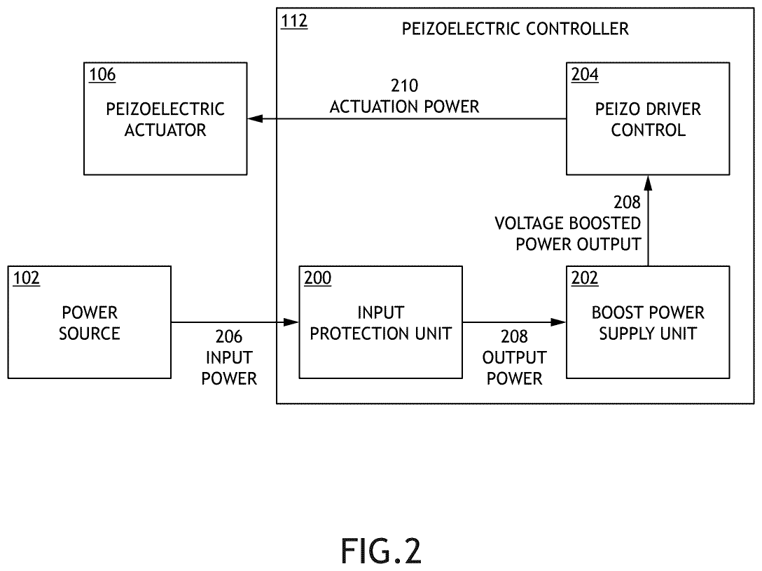

FIG. 2 illustrates an enhanced conceptual view of a deicing system 100 for an air data probe 102, in accordance with one or more embodiments of the present disclosure. In embodiments, the piezoelectric controller 112 includes an input protection unit 200 a boost power supply unit 202, and a piezo driver control 204. The input protection unit 200 receives an input power 206 from the aircraft (e.g., aircraft 104) and outputs a power output to boost power supply unit 202. In embodiments, the input power may be about 18 VDC to about 96 VDC, and more specifically, about 28 VDC. In embodiments, the input power 206 may be about 120 VAC to about 380 VAC, and more specifically, about 200 VAC to about 300 VAC. The input protection unit 200 protects the deicing system 100 from voltage and/or current surges from input power 206.

The boost power supply unit 202 receives the output power from the input protection unit 200 and provides a voltage-boosted power output 208 to the piezo driver control 204. The piezo driver control 204 provides an actuation power 210 to each of the one or more piezoelectric actuators 110. Processor 114, in various embodiments, controls the input protection unit 200, the boost power supply unit 202 and/or the piezo driver control 204.

The one or more processors 114 of piezoelectric controller 112 may include any one or more processing elements known in the art. In this sense, the one or more processors 114 may include any microprocessor-type device configured to execute software algorithms and/or instructions. In embodiments, the one or more processors 114 may consist of a desktop computer, mainframe computer system, workstation, image computer, parallel processor, or other computer system (e.g., networked computer) configured to execute a program configured to operate the deicing system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium 116. Moreover, different subsystems of the system 100 (e.g., ice detector) may include a processor or logic elements suitable for carrying out at least a portion of the steps described throughout the present disclosure.

The memory medium 116 may include any memory medium known in the art suitable for storing program instructions executable by the associated one or more processors 114. For example, the memory medium 116 may include, but is not limited to, a read-only memory, a random-access memory, a magnetic or optical memory device (e.g., disk), a magnetic tape, a solid-state drive, and the like. In embodiments, the memory medium 116 is configured to store one or more results from the deicing system 100 an/or the output of the various data processing steps described herein. It is further noted that memory medium 116 may be housed in a common controller housing with the one or more processors 114. In an alternative embodiment, the memory medium 116 may be located remotely with respect to the physical location of the processors and controller 112. For instance, the one or more processors 114 of controller 112 may access a remote memory (e.g., server), accessible through a network (e.g., internet, intranet and the like).

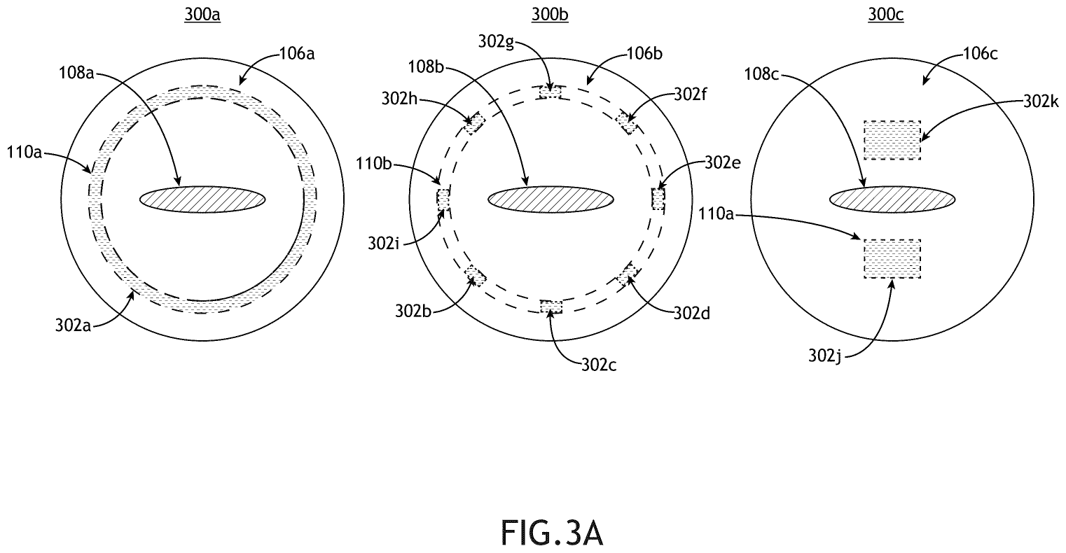

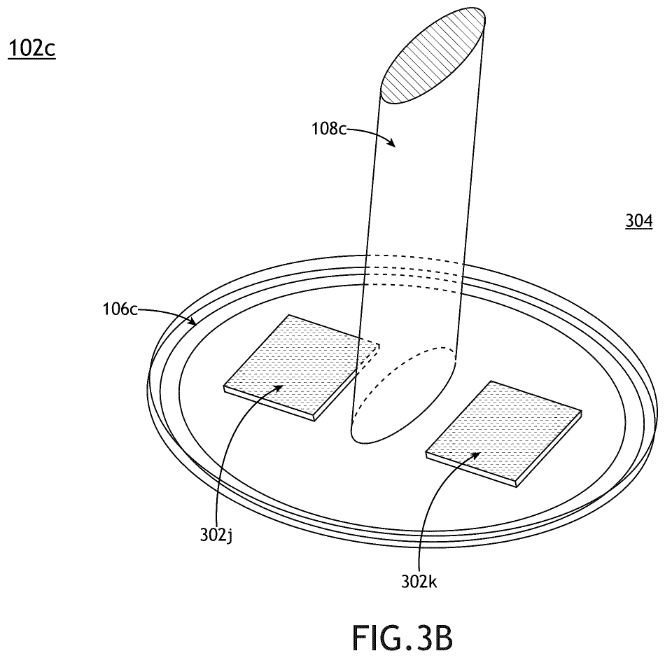

FIG. 3A illustrates plan views 300a-c of three air data probes 102a-c, in accordance with one or more embodiments of the disclosure. Each plan view 300a-c includes a sensor body 108a-c extending outward from a faceplate 106a-c.

In embodiments, the deicing system 100 includes one or more piezoelectric actuators 110a-c (e.g., individual patches 302a-k of the one or more piezoelectric actuators 110) positioned on or within the faceplate 106a-c. For example, the deicing system 100 may include one or more piezoelectric patches 302a arranged in a contiguous path around the probe body 108a (e.g., in a rectangular, ovoid, or other polygonal shape). In another example, the deicing system 100 may include one or more piezoelectric patches 302c-i arranged in a discontinuous path around the probe body (e.g., in a rectangular, ovoid, or other polygonal shape). For instance, the one or more piezoelectric patches 302c-i may be arranged around the probe body 108b in an organized manner, with constant or near-constant spacing between adjacent piezoelectric patches. In another example, the deicing system 100 may include two sets of piezoelectric patches 302j-k arranged on opposite sides of the probe body 108. A perspective view of air data probe 102c disposed on an aircraft surface 304 is illustrated in FIG. 3B.

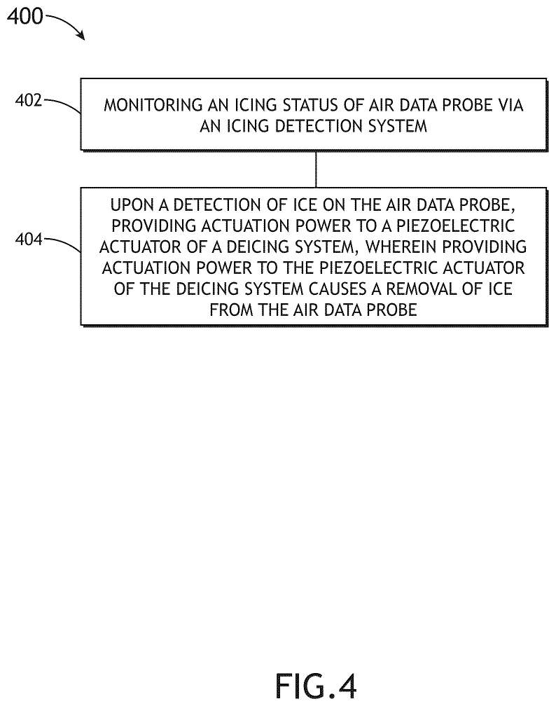

FIG. 4 illustrates a process flow diagram depicting a method 400 for deicing a component of an air data probe 102, in accordance with one or more embodiments of the disclosure. For example, the method 400 may be used for deicing an air data probe 102, such as a pitot probe or an aircraft 104, as described herein.

In embodiments, the method 400 includes a step 402 of monitoring an icing status of air data probe 102 via an icing detection system. For example, the ice detector may be monitoring the air data probe 102 for the formation of ice. In another example, the piezoelectric controller 112 may monitor ice formation by detecting voltages produced by the one or more piezoelectric actuators 110 when the one or more piezoelectric actuators 110 are not activated to deice the air data probe 102.

In embodiments, the method 400 includes a step 404 of, upon a detection of ice on the air data probe 102, providing actuation power to one or more piezoelectric actuators 110 of a deicing system 100, wherein providing actuation power to the one or more piezoelectric actuators 110 of the deicing system 100 causes a removal of ice from the air data probe 102.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable and/or wirelessly interacting components, and/or logically interacting and/or logically interactable components.

All of the methods described herein may include storing results of one or more steps of the method embodiments in a memory medium. The results may include any of the results described herein and may be stored in any manner known in the art. The memory medium may include any memory medium described herein or any other suitable memory medium known in the art. After the results have been stored, the results can be accessed in the memory medium and used by any of the method or system embodiments described herein, formatted for display to a user, used by another software module, method, or system, etc. Furthermore, the results may be stored “permanently,” “semi-permanently,” temporarily,” or for some period of time. For example, the memory medium may be random access memory (RAM), and the results may not necessarily persist indefinitely in the memory medium.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A deicing system comprising:
a piezoelectric actuator coupled to an air data probe and configured to vibrate a surface of the air data probe, wherein a vibration of the surface of the air data probe causes a removal of ice from the surface of the air data probe; and
a piezoelectric controller configured to control the vibration of the surface of the air data probe by the piezoelectric actuator.

2. The deicing system of claim 1, wherein the piezoelectric actuator is positioned within or upon a faceplate of the air data probe.

3. The deicing system of claim 1, wherein the piezoelectric actuator is positioned upon an inner side of a faceplate of the air data probe.

4. The deicing system of claim 1, wherein the piezoelectric actuator is positioned inside a groove within a faceplate of the air data probe.

5. The deicing system of claim 1, wherein the piezoelectric actuator is activated upon a detection of ice on the air data probe.

6. The deicing system of claim 5, wherein the detection of ice is caused by a monitoring voltage generated by the piezoelectric actuator.

7. The deicing system of claim 1, wherein the piezoelectric actuator is configured to vibrate at a frequency equal to or greater than 20 kHz.

8. The deicing system of claim 1, further including a heat element controlled by a heat element controller.

9. The deicing system, of claim 1, further comprising at least one of a faceplate or probe body of the air data probe.

10. The deicing system of claim 1, wherein the air data probe comprises at least one of a pitot probe, a total air temperature probe, or an angle of attack probe.

11. The deicing system of claim 1, wherein the air data probe comprises a pitot probe.

12. The deicing system of claim 1, wherein the piezoelectric controller comprises:
an input protection unit configured to receive input power from a power source and output a power output;
a boost power supply unit configured to receive the power output and provide a voltage-boosted power output; and
a piezoelectric driver control unit electrically coupled configured to the piezoelectric actuator and configured to receive the voltage-boosted power output and provide an actuation power to the piezoelectric actuator.

13. The deicing system of claim 1, wherein the air data probe comprises a probe body and a faceplate, wherein the probe body extends outward from the faceplate, wherein the piezoelectric actuator comprises one or more piezoelectric patches positioned on or within the faceplate.

14. The deicing system of claim 13, wherein the faceplate comprises one or more piezoelectric patches arranged in a contiguous path around the probe body.

15. The deicing system of claim 13, wherein the faceplate comprises one or more piezoelectric patches arranged in a discontinuous path around the probe body.

16. The deicing system of claim 13, wherein the faceplate comprises two sets of piezoelectric patches positioned on opposite sides of the probe body.

17. A system comprising:
an air data probe comprising:
a faceplate:
a probe body extending outward from the faceplate; and
a piezoelectric actuator coupled to the faceplate and configured to vibrate a surface of the air data probe, wherein a vibration of the surface of the air data probe causes a removal of ice from the surface of the air data probe; and
a piezoelectric controller configured to control the vibration of the surface of the air data probe by the piezoelectric actuator.

18. The system of claim 17, wherein the air data probe comprises at least one of a pitot probe, an aspirated total air temperature probe, a flush total air temperature probe, a static port, or an angle of attack probe.

19. The system of claim 17, wherein the piezoelectric controller comprises:
an input protection unit configured to receive input power from a power source and output a power output;
a boost power supply unit configured to receive the power output and provide a voltage-boosted power output; and
a piezoelectric driver control unit electrically coupled configured to the piezoelectric actuator and configured to receive the voltage-boosted power output and provide an actuation power to the piezoelectric actuator.

20. A system for deicing a component of an air data probe comprising:
monitoring an icing status of air data probe via an icing detection system; and
upon a detection of ice on the air data probe, providing actuation power to a piezoelectric actuator of a deicing system, wherein providing actuation power to the piezoelectric actuator of the deicing system causes a removal of ice from the air data probe.
